(19) United States
(12) Patent Application Publication
(10) Pub. No.: US 2017/0361296 A1
(43) Pub. Date: Dec. 21, 2017

(54) FUEL REFORMER

(71) Applicant: DENSO CORPORATION, Kariya-city, Aichi-pref. (JP)

(72) Inventors: Kenji AOYAGI, Kariya-city (JP); Yousuke NAKAGAWA, Kariya-city (JP)

(21) Appl. No.: 15/540,654

(22) PCT Filed: Dec. 21, 2015
(86) PCT No.: PCT/JP2015/006354

§ 371 Date: Jun. 29, 2017

(30) Foreign Application Priority Data
Jan. 13, 2015 (JP) 2015-004422

(51) Int. Cl. B01J 10/00; F02M 26/36; C01B 3/38; B01J 19/00; F02M 27/02

(52) U.S. Cl. CPC B01J 10/007; B01J 19/0006; F02M 27/02; C01B 3/384; F02M 26/36; B01J 2219/00164; C01B 2203/0811; C01B 2203/169; C01B 2203/0233

(57) ABSTRACT

A fuel reformer for producing a steam reforming reaction between fuel and water on a reforming catalyst includes a fuel injection part that injects and supplies fuel into the reforming catalyst, and an injection control part that controls an injection amount of fuel by the fuel injection part. The injection control part controls the injection amount in order that a temperature of the reforming catalyst is not lower than a preset given temperature. The fuel reformer further includes a temperature obtaining part that measures or estimates the temperature of the reforming catalyst, and a target value calculation part that calculates a target value of the injection amount, such that the temperature of the reforming catalyst after fuel is injected by the fuel injection part is equal to or higher than the given temperature. The fuel injection part is controlled such that the injection amount coincides with the target value.

### CROSS REFERENCE TO RELATED APPLICATION

This application is based on Japanese Patent Application No. 2015-4422 filed on Jan. 13, 2015, the disclosure of which is incorporated herein by reference.

### TECHNICAL FIELD

The present disclosure relates to a fuel reformer that causes a steam reforming reaction between fuel and water on a reforming catalyst.

### BACKGROUND ART

A vehicle having a fuel reformer has been proposed (e.g., Patent Document 1 below), and an intense effort is being made to advance development toward its practical use. The fuel reformer produces a reaction (steam reforming reaction) between water contained in exhaust gas discharged from an internal-combustion engine of the vehicle, and fuel such as ethanol, on a reforming catalyst to supply hydrogen obtained by this reaction to the internal-combustion engine.

Such a fuel reformer can recover the heat energy of exhaust gas by the steam reforming reaction, which is an endothermic reaction, and can convert the recovered heat energy into chemical energy such as hydrogen or carbon monoxide to reuse the heat energy. The use of fuel energy with high efficiency can restrain the fuel consumption amount of the vehicle.

To efficiently cause the steam reforming reaction on the reforming catalyst, the fuel needs to be supplied (injected) into the reforming catalyst, with the temperature of the reforming catalyst maintained at an approximately catalyst active temperature or at a temperature higher than this temperature. However, since the steam reforming reaction is an endothermic reaction, as the reaction progresses, the temperature of the reforming catalyst decreases to be lower than the catalyst active temperature, and thus the steam reforming reaction may be inhibited.

For this reason, at the time of the low temperature of the reforming catalyst, the fuel reformer described in Patent Document 1 below increases the temperature of the reforming catalyst beforehand prior to the steam reforming reaction. Specifically, an exothermic reaction between fuel and oxygen is initiated by supplying oxygen to the reforming catalyst. The temperature of the reforming catalyst increases by this reaction, so that the steam reforming reaction can be subsequently produced.

### PRIOR ART DOCUMENT

### Patent Document

Patent Document 1: JP2013-133253A

Nevertheless, because the fuel reformer is for recovering and reusing the heat energy included in exhaust gas thereby to restrain the fuel consumption amount, the consumption of a part of fuel to increase the temperature of the reforming catalyst is undesirable. To effectively use the energy, it is desirable to consume all the fuel injected in the fuel reformer for the steam reforming reaction.

### SUMMARY OF INVENTION

The present disclosure addresses the above issues. Thus, it is an objective of the present disclosure to provide a fuel reformer that can efficiently achieve energy recovery by a steam reforming reaction without consuming a part of fuel for an exothermic reaction.

To achieve the objective, a fuel reformer in an aspect of the present disclosure produces a steam reforming reaction between fuel and water on a reforming catalyst, and includes a fuel injection part that injects and supplies fuel into the reforming catalyst, and an injection control part that controls an injection amount of fuel by the fuel injection part. The injection control part controls the injection amount in order that a temperature of the reforming catalyst is not lower than a preset given temperature.

In the fuel reformer having such a configuration, the fuel injection amount is controlled appropriately by the injection control part in order that the temperature of the reforming catalyst is not lower than a preset given temperature. For example, setting a catalyst active temperature of the reforming catalyst as this given temperature can constantly produce the steam reforming reaction in the reforming catalyst with high efficiency.

Thus, in the fuel reformer in this aspect, it is not that the temperature of the reforming catalyst is increased beforehand, and then the steam reforming reaction is caused. Instead, only such an amount of fuel that the temperature decrease amount of the reforming catalyst is negligible is injected into the reforming catalyst. Since a part of the injected fuel is not consumed for an exothermic reaction, the energy recovery by the steam reforming reaction is efficiently achieved.

This aspect provides the fuel reformer that can efficiently achieve the energy recovery by the steam reforming reaction.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically illustrating a configuration of a fuel reformer in accordance with an embodiment;

FIG. 2 is a flow chart showing a flow of processing performed by a control part of the fuel reformer illustrated in FIG. 1;

FIG. 3 is a graph showing a temperature change of a reforming catalyst according to the embodiment; and

FIG. 4 is a diagram showing a modification to the fuel reformer illustrated in FIG. 1.

### EMBODIMENT FOR CARRYING OUT INVENTION

An embodiment will be described below with reference to the accompanying drawings. To facilitate the understanding of explanation, the same reference numeral is given as far as possible to the same component in each drawing to omit repeated explanations.

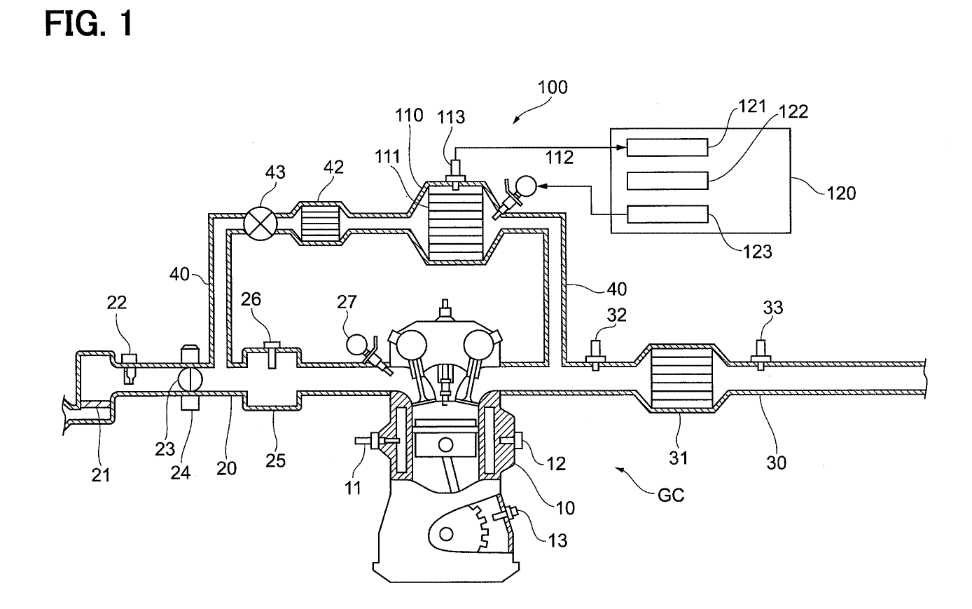

A fuel reformer 100 of the embodiment will be described with reference to FIG. 1. The fuel reformer 100 is attached to a part of a vehicle GC including an internal-combustion engine 10, and is a device for recovering and reusing the heat of exhaust gas discharged from the internal-combustion engine 10.

First, the configuration of the vehicle GC will be explained. The vehicle GC includes the internal-combustion engine 10, an intake pipe 20, an exhaust pipe 30, and an EGR pipe 40.

The internal-combustion engine 10 is a four-cycle reciprocating engine having cylinders, for generating driving force by combusting liquid fuel in the cylinders. The configuration of each cylinder is generally the same, and only a single cylinder is thus illustrated in FIG. 1 as the “internal-combustion engine 10.”

Various sensors such as a coolant temperature sensor 11, a knock sensor 12, and a crank angle sensor 13 are attached to each cylinder of the internal-combustion engine 10. The coolant temperature sensor 11 is a temperature sensor for measuring the temperature of coolant circulating between a radiator (not shown) and the internal-combustion engine 10. The knock sensor 12 is a sensor for detecting a knocking (abnormal combustion) caused in the cylinder of the internal-combustion engine 10. The crank angle sensor 13 is a sensor for measuring a rotation angle of a crankshaft of the cylinders. The measurement values obtained by these sensors are inputted into an ECU (not shown) that controls the entire vehicle GC.

The intake pipe 20 is a pipe for supplying air into the internal-combustion engine 10. An air cleaner 21, an air flow meter 22, a throttle valve 23, a surge tank 25, and a first injector 27 are provided for the intake pipe 20 in this order from the upstream side (left side in FIG. 1). The internal-combustion engine 10 is connected to the downstream end part (right side in FIG. 1) of the intake pipe 20.

The air cleaner 21 is a filter for removing foreign substances from the air, which is introduced from the outside of the vehicle GC. The air flow meter 22 is a flow meter for measuring a flow rate of air supplied into the internal-combustion engine 10 through the intake pipe 20. The flow rate measured by the air flow meter 22 is inputted into the ECU of the vehicle GC.

The throttle valve 23 is a flow regulation valve for regulating the flow rate of air through the intake pipe 20. In accordance with the operation amount of an accelerator pedal (not shown) of the vehicle GC, the opening degree of the throttle valve 23 is adjusted thereby to regulate the flow rate of air. The throttle valve 23 includes an opening degree sensor 24. The opening degree of the throttle valve 23 is measured by the opening degree sensor 24 and is inputted into the ECU of the vehicle GC.

The surge tank 25 is a box-shaped container that is formed at the intake pipe 20. The intake pipe 20 is divided into more than one branch on a downstream side of the surge tank 25. Each branched flow passage is connected to a corresponding cylinder. The internal space of the surge tank 25 is larger than the internal space of the other part of the intake pipe 20. The surge tank 25 prevents an influence of a pressure change by one cylinder on the other cylinders. The surge tank 25 includes a pressure sensor 26. The pressure in the intake pipe 20 is measured by the pressure sensor 26 and is inputted into the ECU of the vehicle GC.

The first injector 27 is an electromagnetic valve for injecting fuel into the intake pipe 20. The fuel pressurized by a fuel pump (not shown) is supplied to the first injector 27. When the first injector 27 is put into an open state, the fuel injected through the end of the injector 27 is mixed with air and supplied into the cylinder of the internal-combustion engine 10. The ECU of the vehicle GC controls the opening and closing operations of the first injector 27 to adjust the amount of fuel supplied to the internal-combustion engine 10.

The exhaust pipe 30 is a pipe for discharging exhaust gas, which is produced in the cylinder of the internal-combustion engine 10, to the outside. The upstream end part (left side in FIG. 1) of the exhaust pipe 30 is connected to the internal-combustion engine 10. A catalytic converter 31 for purifying exhaust gas is provided at the exhaust pipe 30 (downstream side of the internal-combustion engine 10).

An air-fuel ratio sensor 32 is provided at the part of the exhaust pipe 30 on an upstream side of the catalytic converter 31, and an oxygen sensor 33 is provided at the part of the exhaust pipe 30 on a downstream side of the catalytic converter 31. These are all sensors for monitoring the oxygen concentration of exhaust gas passing through the exhaust pipe 30, and their measurement results are inputted into the ECU of the vehicle GC. Based on the measurement results by the air-fuel ratio sensor 32 and so forth, the ECU controls, for example, the amount of fuel injected by the first injector 27 so that the combustion in the internal-combustion engine 10 is carried out at a theoretical air-fuel ratio.

The EGR pipe 40 is a pipe for returning a part of exhaust gas passing through the exhaust pipe 30 into the intake pipe 20 to supply the gas to the internal-combustion engine 10 again (for performing “exhaust gas recirculation”). The upstream end part of the EGR pipe 40 is connected to the position of the exhaust pipe 30 between the internal-combustion engine 10 and the catalytic converter 31. The downstream end part of the EGR pipe 40 is connected to the position of the intake pipe 20 between the throttle valve 23 and the surge tank 25.

An EGR cooler 42 and an EGR valve 43 are provided at the EGR pipe 40 in this order from the upstream side. A reforming unit part 110, which is a part of the fuel reformer 100, is provided at the part of the EGR pipe 40 on an upstream side of the EGR valve 43. The reforming unit part 110 will be described later.

The EGR cooler 42 is a cooler for cooling high-temperature exhaust gas to reduce its temperature beforehand, and then for supplying the gas to the intake pipe 20. The EGR valve 43 is a flow regulation valve for regulating the flow rate of exhaust gas passing through the EGR pipe 40. The ECU of the vehicle GC regulates the opening degree of the EGR valve 43 to adjust a rate of the exhaust gas flowing into the EGR pipe 40 to the exhaust gas passing through the exhaust pipe 30, i.e., an EGR rate.

The specific configuration of the vehicle GC is not limited to the above, and the fuel reformer of the present disclosure can be disposed in a variously-configured vehicle. For example, the connecting position of the EGR pipe 40 at the exhaust pipe 30 may be on a downstream side of the catalytic converter 31. The vehicle GC may include a supercharging device.

The configuration of the fuel reformer 100 will be described. The fuel reformer 100 includes the reforming unit part 110 and a control part 120. The reforming unit part 110 is provided at the part of the EGR pipe 40 on an upstream side of the EGR cooler 42 (exhaust pipe 30-side). The reforming unit part 110 includes therein a space leading to the EGR pipe 40, and is configured such that this space is filled with a reforming catalyst 111.

The reforming catalyst 111 is a “monolithic” catalyst that is formed from alumina. Grid-like flow passages are formed along the passage direction of the EGR pipe 40 at the reforming catalyst 111, and a catalyst material is supported on the inner wall surface of each flow passage.

A temperature sensor 113 for measuring a temperature of the reforming catalyst 111 is provided at the reforming unit part 110. The temperature of the reforming catalyst 111 is measured by the temperature sensor 113, and is inputted into the control part 120.

A second injector 112 is provided at the part of the reforming unit part 110 on an upstream side of the reforming catalyst 111. The second injector 112 is an electromagnetic valve configured similar to the first injector 27, which is provided for the internal-combustion engine 10, and can inject fuel (ethanol) into the space on an upstream side of the reforming catalyst 111. The opening/closing operation of the second injector 112, i.e., the fuel injection, is controlled by the control part 120, which will be described later.

The injection of fuel from the second injector 112 is carried out when EGR control is performed by the ECU of the vehicle GC, i.e., when the EGR valve 43 is in an open state and exhaust gas passes through the EGR pipe 40. When fuel is injected by the second injector 112, the water contained in exhaust gas and the fuel are supplied into the reforming catalyst 111 in a mixed state in the reforming unit part 110.

The reforming catalyst 111 is heated by the exhaust gas passing through the reforming unit part 110 to have high temperature. When the water and fuel (hydrocarbon) come into contact with the high-temperature reforming catalyst 111, a steam reforming reaction is triggered between these to produce hydrogen and carbon monoxide.

The exhaust gas becomes hydrogen-containing gas by passing through the reforming unit part 110, and is supplied into the intake pipe 20. After that, the hydrogen-containing gas (exhaust gas) is supplied into the cylinder of the internal-combustion engine 10 for combustion again.

As is well-recognized, the steam reforming reaction produced in the reforming unit part 110 is an endothermic reaction, so that the exhaust gas is cooled to become the hydrogen-containing gas with its temperature lowered. Thus, the heat energy of exhaust gas is recovered by the steam reforming reaction in the reforming unit part 110, and is converted into chemical energy of hydrogen. The fuel reformer 100 recovers the heat energy of exhaust gas and converts it into the chemical energy, and then uses this chemical energy again in the internal-combustion engine 10 to improve the energy use efficiency of fuel. Such a fuel reformer 100 can improve the fuel efficiency of the vehicle GC.

The control part 120 is a computer system including a CPU, a ROM, a RAM, and an input/output interface. The control part 120 includes a temperature obtaining part 121, a target value calculation part 122, and an injection control part 123 as functional control blocks.

The temperature obtaining part 121 is a part into which the signal from the temperature sensor 113 is inputted. Based on the signal inputted from the temperature sensor 113, the temperature obtaining part 121 obtains the temperature of the reforming catalyst 111.

The target value calculation part 122 is a part that calculates the target injection amount, which is a target value of the amount of fuel injected by the second injector 112 (hereinafter also referred to simply as an “injection amount”). The specific method of calculating the target injection amount will be described later.

The injection control part 123 is a part that controls the opening and closing operations of the second injector 112 by supplying a driving current to the second injector 112. The injection control part 123 controls the opening and closing operations of the second injector 112 so that the injection amount of the second injector 112 reaches the target injection amount calculated by the target value calculation part 122.

As described above, the signal from the temperature sensor 113 is inputted into the control part 120, and furthermore, a variety of information is inputted into the control part 120 through communication with the ECU (not shown) of the vehicle GC. For example, the opening degree of the EGR valve 43 or information such as operating conditions (e.g., the rotation speed or the load magnitude of the internal-combustion engine 10) of the vehicle GC is inputted into the control part 120 from the ECU of the vehicle GC.

The steam reforming reaction has weak reactivity at a low temperature, and is actively produced approximately at a temperature (catalyst active temperature) at which the reforming catalyst 111 is activated or at a temperature higher than this temperature. Thus, the injection of fuel from the second injector 112 is not performed constantly during the EGR control, but is performed only when it is confirmed by the temperature sensor 113 that the reforming catalyst 111 has reached a high temperature. When fuel is injected by the second injector 112, the temperature of the reforming catalyst 111 decreases under the influence of the endothermic reaction. The control part 120 controls the opening and closing operations of the second injector 112 in order that the temperature of the reforming catalyst 111 is not lower than the catalyst active temperature due to the fuel injection.

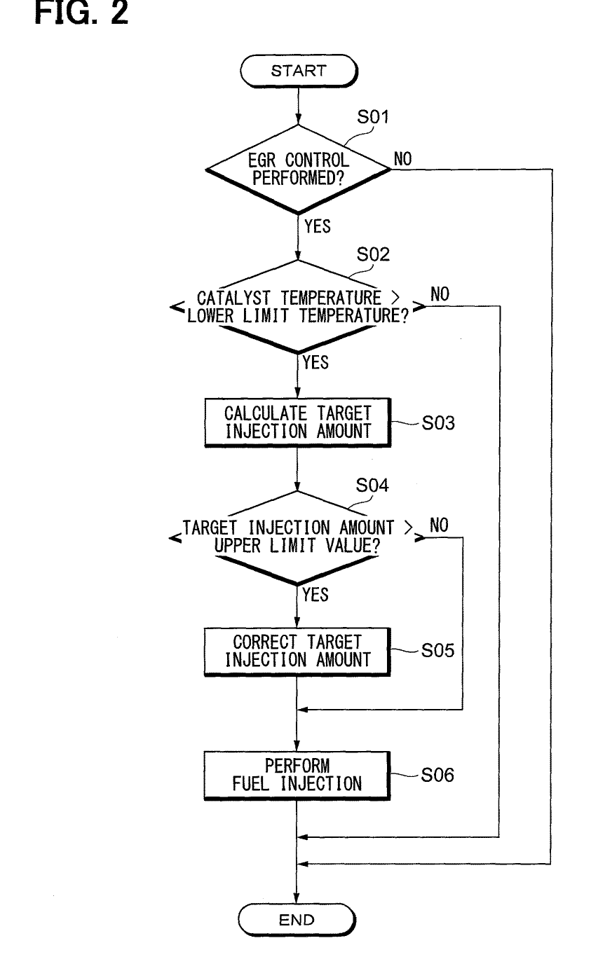

The specific content of processing performed by the control part 120 will be described with reference to the flow chart in FIG. 2. A series of processing illustrated in FIG. 2 is carried out repeatedly with a predetermined period.

At the first step S01, it is determined whether the EGR control is performed in the vehicle GC. If the EGR control is performed, i.e., if the EGR valve 43 is in an open state and exhaust gas passes through the EGR pipe 40, control proceeds to S02. If the EGR control is not performed, i.e., if the EGR valve 43 is in a closed state, the series of processing illustrated in FIG. 2 is ended.

At S02, it is determined whether the temperature of the reforming catalyst 111 measured by the temperature sensor 113 is higher than a preset lower limit temperature. The lower limit temperature is preset as the temperature that should be ensured at the minimum to sufficiently produce the steam reforming at the reforming catalyst 111 while the fuel reformer 100 is in operation. In the present embodiment, the value (e.g., 500° C.) that is equal to the catalyst active temperature is set as the lower limit temperature.

If the temperature of the reforming catalyst 111 is higher than the lower limit temperature, control proceeds to S03. If the temperature of the reforming catalyst 111 is equal to or lower than the lower limit temperature, this means that the temperature of the reforming catalyst 111 becomes lower than the lower limit temperature due to the fuel injection, and thus control ends the series of processing illustrated in FIG. 2.

At S03, the target injection amount is calculated by the target value calculation part 122. The target injection amount is calculated, such that a temperature decrease amount of the reforming catalyst 111 when the fuel injection is carried out does not exceed the temperature difference obtained by subtracting the lower limit temperature from the temperature of the reforming catalyst 111 at the present time (which can also be called a temperature decrease amount permitted in the reforming catalyst 111 and hereinafter also referred to as a “permissible temperature decrease amount”).

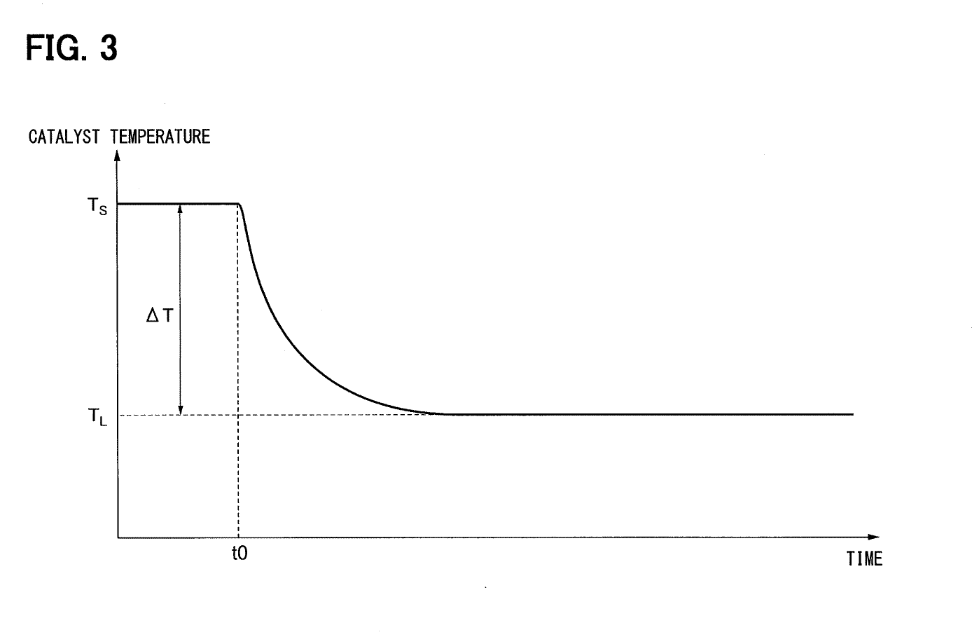

FIG. 3 illustrates an example of the temperature change of the reforming catalyst 111 when fuel is injected by the second injector 112. An initial temperature T_{S} of the reforming catalyst 111 at the time before fuel is injected starts to decrease from the time t0 that fuel is injected, to eventually reach a generally constant value. If a temperature decrease amount in this case is too great, the temperature of the reforming catalyst 111 becomes lower than the lower limit temperature (hereinafter also written as “lower limit temperature T_{L}”).

The temperature decrease amount becomes larger as the injection amount becomes larger, and becomes smaller as the injection amount becomes smaller. The relationship between the temperature decrease amount and the injection amount is obtained beforehand through experiment or the like, and is stored as a map in a storage device (not shown) of the control part 120. At S03, the target injection amount is calculated based on this map and the permissible temperature decrease amount.

In the present embodiment, the target injection amount is calculated so that the temperature decrease amount due to the injection corresponds to a difference ΔT between the initial temperature T_{S} and the lower limit temperature T_{L} (i.e., permissible temperature decrease amount). In other words, the target injection amount is calculated, such that the temperature of the reforming catalyst 111 after the fuel injection is carried out is not lower than the lower limit temperature T_{L} and generally corresponds to the lower limit temperature T_{L}.

The relationship between the temperature decrease amount and the injection amount is not constantly the same, and varies according to, for example, the initial temperature T_{S} of the reforming catalyst 111, a speed at which exhaust gas and fuel pass through the reforming catalyst 111, the EGR rate, the operating conditions of the vehicle GC, and the kind of fuel injected from the second injector 112. Thus, more than one map indicating the relationship between the temperature decrease amount and the injection amount may preferably be provided in view of these factors (or as a multidimensional map). At S03, an appropriate map is selected based on the information on the above factor (e.g., flow speed of exhaust gas or the like passing through the EGR pipe 40) obtained from the ECU of the vehicle GC, and the target injection amount is calculated more accurately based on this map and the permissible temperature decrease amount.

At the step S04, which follows the step S03, it is determined whether the calculated target injection amount exceeds an upper limit value. The upper limit value is a value that is calculated beforehand by the control part 120 as such an injection amount that the temperature decrease amount of the reforming catalyst 111 is maximized. The upper limit value may also be such an injection amount that the steam reforming reaction caused in the reforming catalyst 111 is saturated (injection amount that maximizes a reforming effect).

The upper limit value is not always constant, and varies according to, for example, the initial temperature T_{S} of the reforming catalyst 111, the EGR rate, and the operating conditions of the vehicle GC. The relationship between the initial temperature T_{S} and so forth, and the upper limit value is stored beforehand as a map in the storage device of the control part 120. When the determination at S04 is made, the upper limit value is calculated each time by reference to this map beforehand.

If the target injection amount exceeds the upper limit value at S04, control proceeds to S05. If the target injection amount is equal to or smaller than the upper limit value, control proceeds to S06.

The target injection amount is corrected at S05. Specifically, the value of the target injection amount is rewritten into the same value as the upper limit value.

At the step S06, which follows the step S04 or the step S05, the injection of fuel from the second injector 112 is performed by the injection control part 123. The injection amount in this case accords with the target injection amount calculated at S03 (or rewritten at S05). Consequently, the final temperature of the reforming catalyst 111 generally corresponds to the lower limit temperature T_{L} as in the example of FIG. 3.

As described above, the fuel reformer 100 of the present embodiment controls the amount of fuel injected by the second injector 112 so that the temperature of the reforming catalyst 111 is not lower than the preset lower limit temperature T_{L} (given temperature). Specifically, the target injection amount (target value) is calculated, such that the temperature of the reforming catalyst 111 after the fuel injection is carried out is equal to or higher than the lower limit temperature T_{L} (e.g., such that the temperature corresponds to the lower limit temperature T_{L}). The operation of the second injector 112 is controlled such that its injection amount coincides with the target injection amount.

The temperature of the reforming catalyst 111 decreases due to the fuel injection, but this temperature is not lower than the lower limit temperature T_{L} and generally accords with the lower limit temperature T_{L}. Thus, in the present embodiment, as much fuel as possible is injected in a range in which the reforming catalyst 111 can fulfill its function, and the recovery of heat energy from exhaust gas is thereby made. Since a part of the injected fuel is not consumed for an exothermic reaction, the energy recovery by the steam reforming reaction is efficiently achieved.

In the present embodiment, the temperature of the reforming catalyst 111 is measured directly by the temperature sensor 113, which is provided at the reforming unit part 110. Instead of such an aspect, an aspect, in which the temperature of the reforming catalyst 111 is calculated by the control part 120 without providing the temperature sensor 113, may be applicable. For example, the relationship between the operating condition of the vehicle GC and the exhaust gas temperature is stored beforehand as a map. Consequently, the temperature of the reforming catalyst 111 can be calculated (estimated) by reference to the current operating condition and this map.

In the present embodiment, the same value as the catalyst active temperature of the reforming catalyst 111 is set as the target value (lower limit temperature T_{L}) of the temperature of the reforming catalyst 111 after fuel is injected. However, when implementing the present disclosure, another value (e.g., value slightly lower than the catalyst active temperature) may be set as the lower limit temperature T_{L}.

The control part 120 may be provided as a separate device from the ECU of the vehicle GC as in the present embodiment, but may be provided integrally with the ECU of the vehicle GC. Thus, the ECU of the vehicle GC may be configured to also serve as the function of the control part 120.

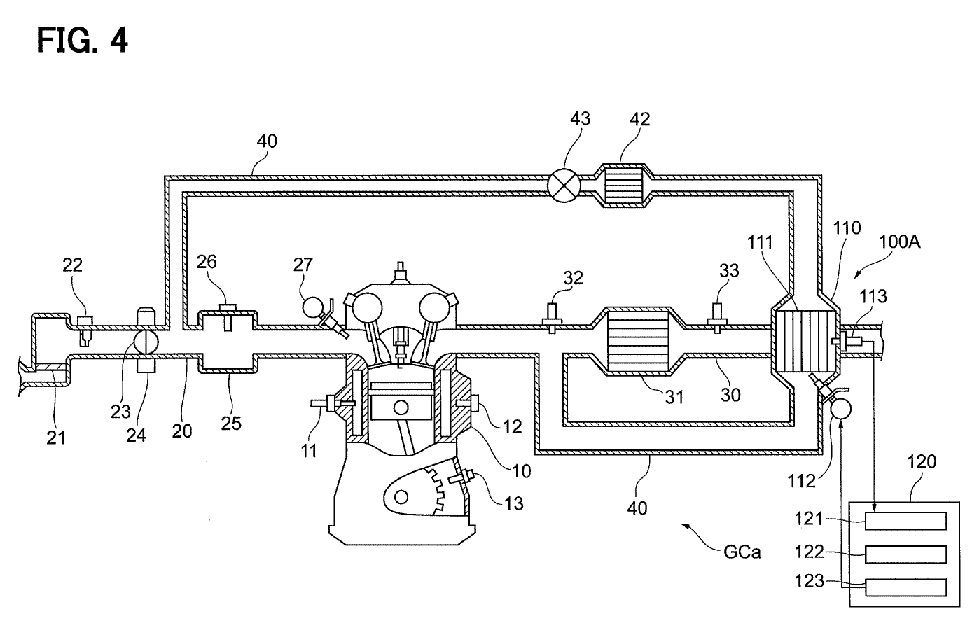

Modifications to the present embodiment will be described with reference to FIG. 4. The configuration of a vehicle GCa illustrated in FIG. 4 is different only in position and structure of the reforming unit part 110 from the configuration of the vehicle GC.

In this modification, the reforming unit part 110 is provided at the part of the exhaust pipe 30 on a downstream side of the catalytic converter 31. The reforming catalyst 111 in the reforming unit part 110 is configured to be heated by the exhaust gas passing through the EGR pipe 40, and also to be heated by the exhaust gas passing through the exhaust pipe 30. Thus, the reforming unit part 110 is configured as a part of the heat exchanger to which both the EGR pipe 40 and the exhaust pipe 30 are connected. Such a configuration can also maintain the temperature of the reforming catalyst 111 at a high temperature by the exhaust gas passing through the exhaust pipe 30. As a consequence, even though a relatively great amount of fuel is injected from the second injector 112, the temperature of the reforming catalyst 111 can be maintained to be equal to or higher than the lower limit temperature T_{L}.

However, in such a configuration, the reforming unit part 110 grows in size and much of the limited space in the vehicle GC is taken by the reforming unit part 110.

In contrast, the fuel reformer 100 configured as illustrated in FIG. 1 has a structure whereby the reforming catalyst 111 is heated only by the exhaust gas passing through the EGR pipe 40 (flow passage in which the reforming catalyst 111 is disposed), thereby enabling the downsizing of the reforming unit part 110.

The heating amount for the reforming catalyst 111 is smaller than in the modification illustrated in FIG. 4, but the temperature of the reforming catalyst 111 does not excessively decrease due to the fuel injection. Thus, the configuration of FIG. 1 that can further downsize the reforming unit part 110 has greater advantages, and may be a more desirable configuration.

The embodiment has been described above with reference to the specific examples. However, the present disclosure is not limited to these specific examples. Thus, those obtained by making appropriate design changes to these specific examples by a person skilled in the art are also included in the scope of the present disclosure as long as they have the characteristics of the present disclosure. For example, the components of each of the above-described specific examples, and their arrangement, materials, conditions, shapes, and sizes are not limited to those illustrated, and can be modified appropriately. In addition, the components of each of the above-described embodiments can be combined as long as technically possible, and the combination of these is also included in the scope of the present disclosure as long as it has the characteristics of the present disclosure.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A fuel reformer for producing a steam reforming reaction between fuel and water on a reforming catalyst, the fuel reformer comprising:
a fuel injection part that injects and supplies fuel into the reforming catalyst; and
an injection control part that controls an injection amount of fuel by the fuel injection part, wherein the injection control part controls the injection amount in order that a temperature of the reforming catalyst is not lower than a preset given temperature.

2. The fuel reformer according to claim 1, further comprising:
a temperature obtaining part that measures or estimates the temperature of the reforming catalyst; and
a target value calculation part that calculates a target value of the injection amount, such that the temperature of the reforming catalyst after fuel is injected by the fuel injection part is equal to or higher than the given temperature, wherein the fuel injection part is controlled such that its injection amount coincides with the target value.

3. The fuel reformer according to claim 2, wherein:
such an injection amount that a temperature decrease amount of the reforming catalyst is maximized is set as an upper limit value of the injection amount; and
when the calculated target value exceeds the upper limit value, the injection control part controls the injection amount to coincide with the upper limit value.

4. The fuel reformer according to claim 3, wherein the target value calculation part calculates the target value based on at least any one of:
a type of fuel;
a speed of fuel passing through the reforming catalyst; and
the temperature of the reforming catalyst immediately before the fuel injection part injects fuel.

5. The fuel reformer according to claim 3, wherein:
the reforming catalyst is disposed in an exhaust gas recirculation flow passage of a vehicle; and
the target value calculation part calculates the target value based on at least one of:
an operating condition of the vehicle; and
an EGR rate of the vehicle.

6. The fuel reformer according to claim 2, wherein the temperature obtaining part measures the temperature of the reforming catalyst based on a signal from a temperature sensor, which is attached to a vicinity of the reforming catalyst.

7. The fuel reformer according to claim 1, wherein:
the reforming catalyst is disposed in an exhaust gas recirculation flow passage, through which exhaust gas discharged from an internal-combustion engine of a vehicle, passes; and
the reforming catalyst is heated only by the exhaust gas passing through the exhaust gas recirculation flow passage.
